(19) United States
(12) Patent Application Publication
(10) Pub. No.: US 2026/0197760 A1
(43) Pub. Date: Jul. 9, 2026

(54) METHOD, DEVICE AND COMPUTER STORAGE MEDIUM OF COMMUNICATION

(71) Applicant: NEC Corporation, Tokyo (JP)

(72) Inventors: Gang WANG, Beijing (CN); Lei CHEN, Beijing (CN); You LI, Beijing (CN); Zonghui XIE, Beijing (CN)

(73) Assignee: NEC Corporation, Tokyo (JP)

(21) Appl. No.: 19/130,774

(22) PCT Filed: Nov. 18, 2022
(86) PCT No.: PCT/CN2022/132798

§ 371 Date: May 16, 2025

(51) Int. Cl. H04W 52/02

(52) U.S. Cl. CPC H04W 52/0235; H04W 52/0212

(57) ABSTRACT

Embodiments of the present disclosure relate to methods, devices and computer readable media of communication. In one aspect, an access network device transmits, to a terminal device, an indication indicating that a LP WUS monitoring is performed in a first cell in which the terminal device enters the LP WUS mode. If the terminal device is in the first cell, the terminal device performs the LP WUS monitoring. In this way, unnecessary LP WUS monitoring may be avoided and further power saving may be achieved.

### TECHNICAL FIELD

Embodiments of the present disclosure generally relate to the field of telecommunication, and in particular, to methods, devices and computer storage media of communication for mobility in a lower-power wake-up signal (LP WUS) mode.

### BACKGROUND

Currently, it has been proposed to use main radio to describe a regular communication device performing normal radio resource control (RRC) states and additionally design a LP WUS receiver to monitor a LP WUS for turn-on of the main radio. When a terminal device is not receiving service, the terminal device may enter a LP WUS mode during which the main radio is switched off and the LP WUS receiver is switched on to monitor the LP WUS. However, mobility in the LP WUS mode is still unclear and needs to be further developed.

### SUMMARY

In general, embodiments of the present disclosure provide methods, devices and computer storage media of communication for mobility in a LP WUS mode.

In a first aspect, there is provided a method of communication. The method comprises: receiving, at a terminal device and from an access network device, an indication indicating that a LP WUS monitoring is performed in a first cell, the terminal device entering the LP WUS mode in the first cell; and in accordance with a determination that the terminal device is in the first cell, performing the LP WUS monitoring.

In a second aspect, there is provided a method of communication. The method comprises: transmitting, at an access network device and to a terminal device, an indication indicating that a LP WUS monitoring is performed in a first cell, the terminal device entering the LP WUS mode in the first cell.

In a third aspect, there is provided a method of communication. The method comprises: receiving, at a first access network device and from a second access network device or a core network device, a paging message for a terminal device, the paging message comprising information of the terminal device for a LP WUS; and determining application of the LP WUS based on the information of the terminal device.

In a fourth aspect, there is provided a method of communication. The method comprises: transmitting, at a second access network device and to a terminal device, an indication that the terminal device enters a LP WUS mode; and storing information of the terminal device for a LP WUS.

In a fifth aspect, there is provided a method of communication. The method comprises: determining, at a terminal device in a low-power wake-up signal, LP WUS, mode, that a cell that the terminal device is camping on is comprised in a set of cells, the terminal device supporting the LP WUS in the set of cells; and keeping monitoring of the LP WUS.

In a sixth aspect, there is provided a method of communication. The method comprises: receiving, at a terminal device and in a cell, a configuration for a LP WUS; and in accordance with a determination that a cell change from the cell to a further cell occurs in a LP WUS mode and the further cell is not comprised in a set of cells in which the terminal device supports the LP WUS, acquiring a further configuration for the LP WUS or exiting the LP WUS mode.

In a seventh aspect, there is provided a device of communication. The device comprises a processor configured to cause the device to perform the method according to any of the first to sixth aspects of the present disclosure.

In an eighth aspect, there is provided a computer readable medium having instructions stored thereon. The instructions, when executed on at least one processor, cause the at least one processor to perform the method according to any of the first to sixth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates an example structure of a terminal device in which some embodiments of the present disclosure can be implemented;

FIG. 1C illustrates a diagram illustrating a LP WUS mechanism in which some embodiments of the present disclosure can be implemented;

FIG. 2 illustrates a schematic diagram illustrating a process of communication according to embodiments of the present disclosure;

FIG. 3 illustrates a schematic diagram illustrating another process of communication according to embodiments of the present disclosure;

FIG. 4 illustrates a schematic diagram illustrating an example process of communication in core network (CN) paging according to embodiments of the present disclosure;

FIG. 5 illustrates a schematic diagram illustrating an example process of communication in random access network (RAN) paging according to embodiments of the present disclosure;

FIG. 6 illustrates a schematic diagram illustrating still another process of communication according to embodiments of the present disclosure;

FIG. 7 illustrates an example method of communication implemented at a terminal device in accordance with some embodiments of the present disclosure;

FIG. 8 illustrates an example method of communication implemented at an access network device in accordance with some embodiments of the present disclosure;

FIG. 9 illustrates another example method of communication implemented at an access network device in accordance with some embodiments of the present disclosure;

FIG. 10 illustrates still another example method of communication implemented at an access network device in accordance with some embodiments of the present disclosure;

FIG. 11 illustrates another example method of communication implemented at a terminal device in accordance with some embodiments of the present disclosure;

FIG. 12 illustrates still another example method of communication implemented at a terminal device in accordance with some embodiments of the present disclosure; and

FIG. 13 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a node in a communication network via which a terminal device accesses the network and receives services therefrom. The communication network may be a CN. The network device in CN (also referred to as core network device herein) may refer to an access management function (AMF), a policy control function (PCF), a session management function (SMF), a user plane function (UPF), unified data management (UDM), unified data repository (UDR), an authentication server function (AUSF), a ProSe key management function (PKMF), a direct discovery name management function (DDNMF), a network exposure function (NEF), etc.,

The communication network may be a RAN. The network device in RAN (also referred to as access network device herein) may refer to a device which is capable of providing or hosting a cell or coverage where terminal devices can communicate. Examples of the access network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “a connected state” may be interchangeably used with “a RRC_CONNECTED state”, the term “an idle state” may be interchangeably used with “a RRC_IDLE state”, and the term “an inactive state” may be interchangeably used with “a RRC_INACTIVE state”.

In general, the fifth generation (5G) devices consume tens of milliwatts in RRC idle or inactive state and hundreds of milliwatts in RRC connected state. Designing to prolong battery life is a necessity for improving energy efficiency as well as for better user experience.

To meet the battery life requirements, an enhanced discontinuous reception (eDRX) cycle with a large value is expected to be used. The eDRX cycle may result in high latency and thus is not suitable for services with requirements of both long battery life and low latency. For example, in fire detection and extinguishment use case, a long eDRX cycle cannot meet the delay requirements. That is, eDRX is apparently not suitable for latency-critical use cases. Thus, it is expected to study an ultra-low power mechanism that can support low latency, e.g., lower than eDRX latency.

As mentioned above, a LP WUS mode is proposed during which main radio is switched off and a LP WUS receiver is switched on to monitor a LP WUS for turn-on of main radio. However, a solution of mobility in the LP WUS mode is still unclear.

Embodiments of the present disclosure provide solutions of communication for mobility in the LP WUS mode. In one aspect, an access network device transmits, to a terminal device, an indication indicating that a LP WUS monitoring is performed in a cell in which the terminal device enters the LP WUS mode. In other words, the terminal device entering the LP WUS mode is triggered by the cell. The cell may also be called as a last used cell or a last serving cell or an anchor cell. Based on the indication, the terminal device performs the LP WUS monitoring if the terminal device is in the cell. In this way, unnecessary LP WUS monitoring may be avoided.

In another aspect, an access network device transmits an indication indicating that the terminal device enters a LP WUS mode, and stores information of the terminal device for a LP WUS. The access network device transmits, to a further access network device, a paging message for the terminal device comprising the information of the terminal device for the LP WUS. Based on the information of the terminal device for the LP WUS, the further access network device determines application of the LP WUS in paging for the terminal device. The terminal device in the LP WUS mode keeps monitoring of a LP WUS if a cell camped on by the terminal device is comprised in a set of cells supporting the LP WUS for the terminal device. In this way, efficient paging via a LP WUS may be achieved.

In still another aspect, a terminal device receives, in a cell, a configuration for a LP WUS. If a cell change from the cell to a further cell occurs in a LP WUS mode and the further cell is not comprised in a set of cells supporting the LP WUS for the terminal device, the terminal device acquires a further configuration for the LP WUS or exits the LP WUS mode. In this way, a proper LP WUS configuration may be ensured during mobility in a LP WUS mode.

Principles and implementations of the present disclosure will be described in detail below with reference to the figures.

### Example of Communication Network

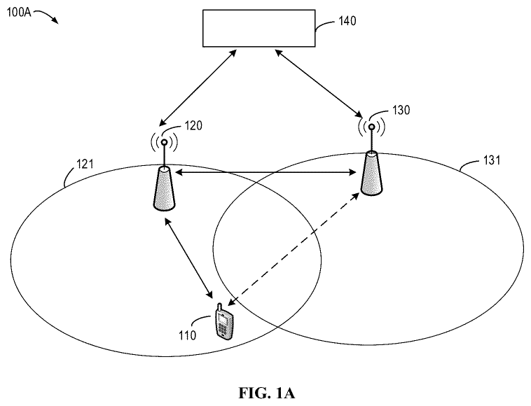

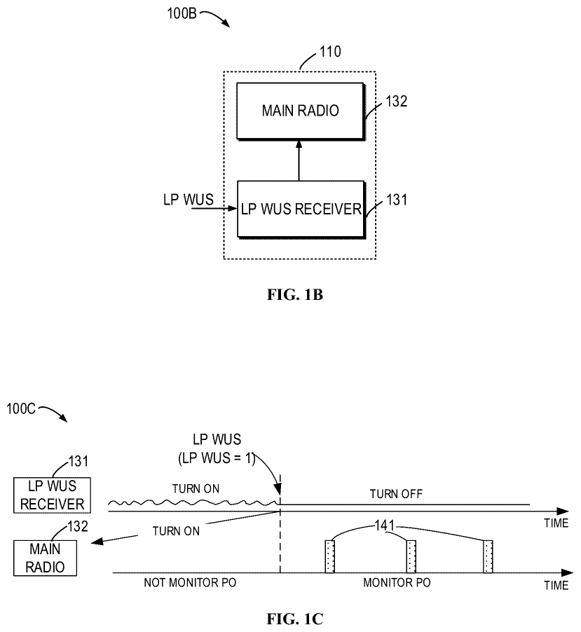

FIG. 1A illustrates a schematic diagram of an example communication network 100A in which some embodiments of the present disclosure can be implemented. As shown in FIG. 1A, the communication network 100A may comprise a terminal device 110 and access network devices 120 and 130. The access network device 120 may provide a serving cell (also referred to as a cell herein) 121 to serve one or more terminal devices. The access network device 130 may also provide a serving cell 131 to serve one or more terminal devices. In this example, the terminal device 110 is shown as being located in the cell 121 and served by the network device 120. In some embodiments, the network devices 120 and 130 may be the same network device. In some embodiments, the network devices 120 and 130 may be different network devices.

As shown in FIG. 1A, the communication network 100A may further comprise a core network device 140. The access network devices 120 and 130 may communicate with the core network device 140 via an Ng interface. The access network devices 120 and 130 may communicate with each other via an Xn interface. The terminal device 110 may communicate with the network device 120 or 130 via a Uu interface.

It is to be understood that the number of devices or cells in FIG. 1A is given for the purpose of illustration without suggesting any limitations to the present disclosure. The communication network 100A may include any suitable number of network devices and/or terminal devices and/cells adapted for implementing implementations of the present disclosure.

The communications in the communication network 100A may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

FIG. 1B illustrates a diagram 100B illustrating a terminal device in which some embodiments of the present disclosure can be implemented. For convenience, FIG. 1B is described in connection with the terminal device 110 of FIG. 1A.

As shown in FIG. 1B, the terminal device 110 may comprise a LP WUS receiver 131 and main radio 132. The LP WUS receiver 131 is configured to monitor a LP WUS. The main radio 132 is configured as a regular communication device performing normal radio resource control (RRC) states.

In some embodiments, the LP WUS receiver 131 may detect the LP WUS indicating turn-off of the main radio 132, and trigger the main radio 132 to enter a turn-off or deep-sleep state. In the turn-off or deep-sleep state, the terminal device 110 is not required to process a RRC idle or inactive or connected state procedure. In some embodiments, the LP WUS receiver 131 may detect the LP WUS indicating turn-on of the main radio 132, and trigger the main radio 132 to enter a turn-on state. In the turn-on state, the main radio 132 may monitor paging occasions (POs). More details will be described in connection with FIG. 1C below.

FIG. 1C illustrates a diagram 100C illustrating a LP WUS mechanism in which some embodiments of the present disclosure can be implemented. For convenience, FIG. 1C is described in connection with FIG. 1B. As shown in FIG. 1C, when the terminal device 110 enters a LP WUS mode, the LP WUS receiver 131 may turn on and the main radio 132 may not monitor POs. When the LP WUS receiver 131 detects a LP WUS (for example, WUS=1) indicating turn-on of the main radio 132, the LP WUS receiver 131 triggers the main radio 132 to turn on and the LP WUS receiver 131 turns off. In this case, the main radio 132 may start monitoring POs 141.

Continue to refer to FIG. 1A, in some scenarios, the terminal device 110 may be in an idle or inactive state. When incoming data is directed to the terminal device 110, the core network device 140 may initiate a paging for the terminal device 110. In this case, the core network device 140 may transmit an Ng paging message for the terminal device 110 to a set of access network devices (e.g., the access network devices 120 and 130). The access network devices 120 and 130 may further transmit, in respective coverages, a Uu paging message for the terminal device 110. These scenarios may be called as a core network (CN) paging.

In some scenarios, the terminal device 110 may be in an inactive state. When incoming data is directed to the terminal device 110, the core network device 140 may transmit the incoming data to the access network device 120 as an anchor cell. Then the access network device 120 may initiate a paging for the terminal device 110. In this case, the access network device 120 may transmit a Uu paging message for the terminal device 110 in its coverage, and may transmit an Xn paging message to other access network devices such as the access network device 130. The access network device 130 may further transmit, in its coverage, a Uu paging message for the terminal device 110. These scenarios may be called as a radio access network (RAN) paging.

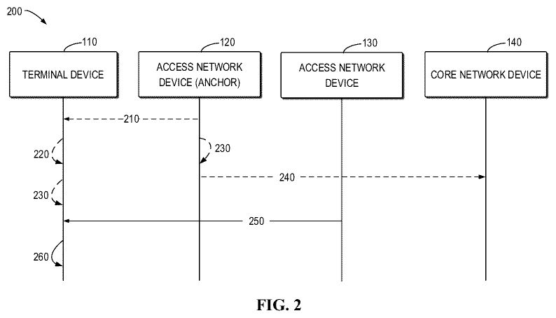

Embodiments of the present disclosure provide solutions for mobility in a LP WUS mode. The detailed description will be made with reference to FIGS. 2 to 6 below.

### Example Implementation of LP WUS Monitoring

In legacy paging mechanism, it is a group mechanism which means multiple UEs share a same resource for paging/WUS/PEI. The paging-initiated side (e.g., AMF, NG-RAN) normally pages a UE in multiple cells, thus causing other UEs who camping on other cell to unnecessarily receive paging/WUS/PEI (i.e., power consumption). A LP WUS may also suffer this situation. Thus, a LP WUS specific mechanism is provided to restrict LP WUS transmission area. The mechanism will be described with reference to FIG. 2.

FIG. 2 illustrates a schematic diagram illustrating a process 200 of communication according to embodiments of the present disclosure. For the purpose of discussion, the process 200 will be described with reference to FIG. 1A. The process 200 may involve the terminal device 110, the access network devices 120 and 130 and the core network device 140 as illustrated in FIG. 1A. It is to be understood that the steps and the order of the steps in FIG. 2 are merely for illustration, and not for limitation. For example, the order of the steps may be changed. Some of the steps may be omitted or any other suitable additional steps may be added. It is assumed that the terminal device 110 is in a LP WUS mode, and the terminal device 110 entering the LP WUS mode is triggered by the cell 121 of the access network device 120. That is, the cell 121 serves as an anchor cell.

As shown in FIG. 2, the access network device 120 may transmit 210, to the terminal device 110, an indication that the terminal device 110 enters a LP WUS mode. In this way, the terminal device 110 entering the LP WUS mode is triggered. In this case, the access network device 120 serves as an anchor network device providing an anchor cell (for convenience, also referred to as a first cell herein). The terminal device 110 enters the LP WUS mode in the anchor cell.

The terminal device 110 may store 220 information of the anchor cell. In this way, the LP WUS monitoring in the anchor cell may be facilitated.

The access network device 120 may store 230 information of the terminal device 110. In this way, an anchor cell may know that the terminal device 110 supports a LP WUS.

Continue to refer to FIG. 2, the access network device 120 may transmit 240, to the core network device 140, information of the anchor cell associated with the terminal device 110. In this way, for CN paging, the core network device 140 may page the terminal device 110 only in the anchor cell in the first time. Thus, paging efficiency may be improved.

With reference to FIG. 2, the terminal device 110 may receive 250 an indication (denoted as lastUsedCellOnly_LPWUS herein) indicating that a LP WUS monitoring is performed in the anchor cell. It is to be understood that the terminal device 110 may receive the indication from any access network device (e.g., the access network device 120 as an anchor network device or the access network device 130 as a non-anchor network device). For convenience, the access network device 130 is shown as an example of an access network device transmitting the indication.

In some embodiments, the terminal device 110 may receive the indication from system information. In some embodiments, the terminal device 110 may receive the indication from a signaling dedicated for the terminal device 110. It is to be understood that the indication may be carried in any other suitable ways.

Based on the indication, the terminal device 110 may determine whether the terminal device 110 is in the anchor cell. If the terminal device 110 is in the anchor cell, the terminal device may perform 260 the LP WUS monitoring. In this way, unnecessary LP WUS monitoring may be avoided.

Some example embodiments will be described in connection with Embodiments 1 and 2 below.

### Embodiment 1

In some embodiments, if a cell change to a target cell (for convenience, also referred to a second cell herein) occurs, the terminal device 110 may acquire system information from an access network device providing the target cell. In some embodiments, the system information may comprise the indication.

In some embodiments, if the target cell is not the anchor cell, the terminal device 110 may not perform the LP WUS monitoring in the target cell. For example, if the target cell is the cell 131, and the terminal device 110 acquires, from the access network device 130, system information comprising the indication, the terminal device 110 may not perform the LP WUS monitoring in the cell 131.

In some embodiments, if the target cell is the anchor cell, the terminal device 110 may perform the LP WUS monitoring in the target cell. For example, if the target cell is the cell 121, and the terminal device 110 acquires, from the access network device 120, system information comprising the indication, the terminal device 110 may perform the LP WUS monitoring in the cell 121.

Alternatively, the system information may not comprise the indication. In this case, the terminal device 110 may perform the LP WUS monitoring in the target cell irrespective of whether the target cell is the anchor cell.

In some embodiments, the system information may comprise an indication indicating that a paging early indication (PEI) monitoring is performed in the anchor cell. In this case, the terminal device 110 may determine that the indication indicating that the LP WUS monitoring is performed in the anchor cell is received. In other words, the indication of PEI monitoring is reused as the indication of LP WUS monitoring.

For illustration, an example UE behavior may be described as below.

UE may monitor LP WUS in LP WUS mode (this mode could be RRC_CONNECTED/INACTIVE/IDLE or any other newly defined state) in order to reduce power consumption. If a LP WUS configuration is provided in a cell, furthermore this configuration can be an area-specific configuration, the UE supporting LP WUS can monitor LP WUS using related parameters in system information.

If lastUsedCellOnly_LPWUS is configured in system information of a cell, the UE monitors LP-WUS in the cell only if the UE most recently entered LP WUS mode which is triggered by this cell, e.g., triggered by RRCRelease, paging, system information, predefined condition. (it means UE will not apply LP WUS mode on other cells but can still store the LPWUS configuration) Otherwise (i.e., if lastUsedCellOnly_LPWUS is not configured in system information of a cell), the UE monitors LP WUS in the camped cell again.

Optionally, legacy PEI lastUsedCellOnly indication can also be shared with this LP WUS mechanism (i.e., reusing the legacy indication).

A LP-WUS-capable UE shall store its last used cell information.

When the UE changes the camped cell during LP WUS mode due to mobility, e.g., the cell change information (i.e., cell identity) can be detected by the UE via LP WUS signaling, SSB, or any other synchronization signaling, the UE shall read the system information of this new cell for checking lastUsedCellOnly_LPWUS reason, to determine whether to monitor LP WUS in this new cell. Once cell change occurs, UE shall switch on the main radio to immediately acquire the LP WUS configuration via system information before continuously monitoring LP WUS on the new cell.

### Embodiment 2

In some embodiments, the terminal device 110 may receive, from an access network device providing an anchor cell, a signaling dedicated for the terminal device 110. The signaling comprises the indication indicating that the LP WUS monitoring is performed in the anchor cell.

In some embodiments, the signaling may be a RRC signaling such as a RRCRelease message or any other suitable messages. In some embodiments, the signaling may be a paging message.

In some embodiments, the signaling may comprise applicable area information. In these embodiments, if the current cell is in an area indicated by the applicable area information and the current cell is the anchor cell, the terminal device 110 may perform the LP WUS monitoring in the current cell. If the current cell is in the area indicated by the applicable area information and the current cell is not the anchor cell, the terminal device 110 may not perform LP WUS monitoring in the current cell.

In some embodiments, if the current cell is out of the area indicated by the applicable area information, the terminal device 110 may perform the LP WUS monitoring in the current cell. For example, the terminal device 110 may determine whether the current cell supports a LP WUS. If the current cell supports the LP WUS, the terminal device 110 may perform the LP WUS monitoring in the current cell.

For illustration, an example UE behavior may be described as below.

UE may monitor LP WUS in LP WUS mode (this mode could be RRC_CONNECTED/INACTIVE/IDLE or any other newly defined state) in order to reduce power consumption. If a LP WUS configuration is provided in a cell, furthermore this configuration can be an area-specific configuration, the UE supporting LP WUS can monitor LP WUS using related parameters in system information.

When a cell transfers the UE to LP WUS mode, if lastUsedCellOnly_LPWUS is provided by this cell via in a dedicated way, e.g., RRCRelease, paging, the UE monitors LP-WUS only in this cell.

Furthermore, the lastUsedCellOnly_LPWUS indication message (e.g., RRCRelease, paging) also carries the configuration applicable area information, e.g., tracking area (TA) list, RAN-based notification area (RNA), or a cell list. The UE monitors LP WUS only in the last used cell when moves in this area. Otherwise (i.e., moves out of this area), the UE monitors LP WUS in the camped cell again. Alternatively, such area information may be not required, the specification can directly specify that this configuration should be common for TA/RNA area.

A LP-WUS-capable UE shall store its last used cell information.

For illustration, an example procedure at a network side may be described as below.

gNBs supporting the LP WUS monitoring to the last used cell function provide the UE's last used cell information to an AMF, e.g., in the NG-AP UE Context Release Complete message for LP WUS capable UEs.

The last used cell needs to store the UE information if this is the cell to transfer the UE to LP-WUS mode by itself.

For CN paging, AMF may page the UE who supports lastUsedCellOnly_LPWUS only in the last used cell in the first time (based on paging policy), if there is no response from UE/NG-RAN, this paging procedure can be escalated, e.g., paging in TA list.

With the process 200, unnecessary LP WUS monitoring and unnecessary UE power consumption may be avoided.

### Example Implementation of Application of LP WUS

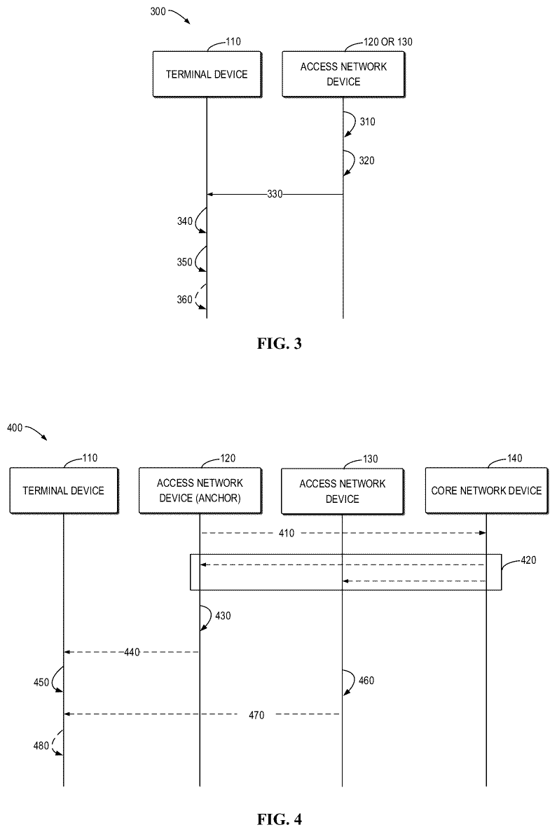

In some scenarios, a network device may provide a cell list for a LP WUS configuration. However, it is still unclear how UE acquires the LP WUS configuration from other cells during mobility. The network device should be aware of this situation for paging the UE. Thus, embodiments of the present disclosure provide a solution of notifying LP WUS information. The solution will be described in connection with FIG. 3.

FIG. 3 illustrates a schematic diagram illustrating a process 300 of communication according to embodiments of the present disclosure. For the purpose of discussion, the process 300 will be described with reference to FIG. 1A. The process 300 may involve the terminal device 110, any of the access network devices 120 and 130, and the core network device 140 as illustrated in FIG. 1A. It is to be understood that the steps and the order of the steps in FIG. 3 are merely for illustration, and not for limitation. For example, the order of the steps may be changed. Some of the steps may be omitted or any other suitable additional steps may be added.

As shown in FIG. 3, an access network device (e.g., the access network device 120 or 130) receives 310 a paging message for the terminal device 110. The paging message comprises information of the terminal device 110 for a LP WUS.

In some embodiments, the paging message may be a CN paging message. In this case, the access network device may be an anchor network device or a non-anchor network device (e.g., the access network device 120 or 130). In some embodiments, the paging message may be RAN paging message. In this case, the access network device may be a non-anchor network device (e.g., the access network device 130).

In some embodiments, the information of the terminal device 110 may comprise an indication indicating that the terminal device 110 supports the LP WUS. That is, the indication indicates capability of the terminal device 110 for the LP WUS. In some embodiments, the information of the terminal device 110 may comprise information of a set of cells in which the terminal device 110 supports the LP WUS, e.g., cell list for LP WUS. In some embodiments, the information of the terminal device 110 may comprise information of an identity (ID) of a group comprising the terminal device 110. The group may refer to a subgroup of a group of terminal devices associated with one occasion. For example, the information of ID of the group may comprise a subgroup ID for LP WUS. In another example, the information of ID of the group may comprise a related configuration used for calculation of the subgroup ID. It is to be understood that the information of the terminal device 110 may comprise any combination of the above information.

Based on the information of the terminal device 110, the access network device determines 320 application of the LP WUS. In other words, the access network device 130 may determine whether to apply the LP WUS for the terminal device 110 and how to apply the LP WUS for the terminal device 110.

In some embodiments, if the paging message comprises the indication indicating that the terminal device 110 supports the LP WUS, the access network device 130 may determine that the LP WUS is applied to the terminal device 110.

In some embodiments, if the paging message comprises the information of the set of cells in which the terminal device 110 supports the LP WUS, the access network device 130 may determine, based on the information of the set of cells, whether the LP WUS is applied to the terminal device 110.

In some embodiments, if the paging message comprises the information of the ID of the group comprising the terminal device 110, the access network device 130 may determine, based on the information of the ID of the group, that the LP WUS is applied to the group.

Continue to refer to FIG. 3, the access network device may provide 330, to the terminal device 110 and in a LP WUS configuration for the terminal device 110, the information of the set of cells in which the terminal device 110 supports the LP WUS. In this way, a network may indicate to UE that which cell the UE shall monitor a LP WUS due to mobility (e.g., cell reselection).

The terminal device 110 in the LP WUS mode may determine 340 whether a cell that the terminal device 110 is camping on is comprised in the set of cells. If the camped cell is comprised in the set of cells, the terminal device 110 may keep 350 monitoring of the LP WUS. If the camped cell is not comprised in the set of cells, the terminal device 110 may stop 360 the monitoring of the LP WUS, and perform an operation related to an idle or inactive state.

For illustration, some example embodiments will be described in connection with Embodiments 3 and 4.

### Embodiment 3

In this embodiment, the paging message is a CN paging message, e.g., an Ng paging message.

FIG. 4 illustrates a schematic diagram illustrating an example process 400 of communication in CN paging according to embodiments of the present disclosure. For the purpose of discussion, the process 400 will be described with reference to FIG. 1A. It is to be understood that the steps and the order of the steps in FIG. 4 are merely for illustration, and not for limitation. For example, the order of the steps may be changed. Some of the steps may be omitted or any other suitable additional steps may be added. It is assumed that the access network device 120 provides an anchor cell and the access network device 130 has no cell comprised in a set of cells in which the terminal device 110 supports a LP WUS.

As shown in FIG. 4, the access network device 120 may transmit 410, to the core network device 140 (e.g., AMF), assistance information for paging. In some embodiments, the assistance information may comprise an indication indicating that the terminal device 110 supports the LP WUS.

In some embodiments, the assistance information may comprise information (e.g., cell list) of a set of cells in which the terminal device 110 supports the LP WUS. In some embodiments, the assistance information may comprise information (e.g., subgroup info) of an ID of a group comprising the terminal device 110. For example, upon transmission of an indication that the terminal device 110 enters a LP WUS mode (i.e., triggering the terminal device 110 entering the LP WUS mode), the access network device 120 may release UE context and transmit, to the core network device 140, a UE Context Release Complete message comprising at least one of the cell list or subgroup info.

It is to be understood that the assistance information may comprise any combination of the above information.

For illustration, an example procedure may be described as below.

The NG-RAN node may provide UE Radio Capability for Paging-LP WUS capability within UE Radio Capability Info Indication message to the AMF.

The NG-RAN node may provide the AMF with the cell list for LP WUS, subgroup info for LP WUS as a assistance information for paging (e.g., via NG-AP UE Context Release Complete message).

Continue to refer to FIG. 4, when incoming data is directed to the terminal device 110, the core network device 140 may transmit 420 an Ng paging message (i.e., the paging message described in FIG. 3) in CN area for paging the terminal device 110. Accordingly, the access network device 130 may receive the Ng paging message.

In some embodiments, the core network device 140 may introduce, in an information element (IE) “UE Radio Capability for Paging” of the Ng paging message, the indication indicating that the terminal device 110 supports the LP WUS. In some embodiments, the core network device 140 may introduce an IE “LP-WUS Assistance Information” in the Ng paging message to carry the information of the set of cells in which the terminal device 110 supports the LP WUS and the information of the ID of the group comprising the terminal device 110. For example, an Ng paging message may be designed as below.

### PAGING

This message is sent by the AMF and is used to page a UE in one or several tracking areas. Direction: AMF→NG-RAN node

IE/Group Name

```
Message Type
UE Paging Identity
Paging DRX
TAI List for Paging
  >TAI List for Paging Item
    >>TAI
Paging Priority
UE Radio Capability for Paging
Paging Origin
Assistance Data for Paging
NB-IoT Paging eDRX Information
NB-IoT Paging DRX
Enhanced Coverage Restriction
WUS Assistance Information
E-UTRA Paging eDRX Information
CE-mode-B Restricted
NR Paging eDRX Information
Paging Cause
PEIPS Assistance Information
LP-WUS Assistence Information
```

The IE “UE Radio Capability for Paging” may be designed as below.

UERadioPagingInformation-v1800-IEs ::= SEQUENCE {

| | |
|---|---|
| ue-RadioPagingInfo-r18 | OCTET STRING (CONTAINING UE-RadioPagingInfo-r18) |

}

| | |
|---|---|
| UE-RadioPagingInfo-r18 ::= | SEQUENCE { |
| lp-wus-SupportBandList-r18 | SEQUENCE (SIZE (1..maxBands)) OF FreqBandIndicatorNR |

...
}

The IE “LP-WUS Assistance Information” may comprise the following items:

Cell list for LPWUS: when present in the (CN) NG paging message received by a gNB, it indicates the gNB whether to apply a LP WUS to wake up the UE based on the cell list prior to sending the Uu paging message to the UE. The cell list includes a list of cells information, each cell information can be denoted by PhysCellId (PCI), CellIdentity (or plus PLMN); and

Subgroup info for LPWUS: a subgroup ID (e.g., integer value) which is used to differentiate a group of UE within one LP WUS occasion, or related configuration used to calculate subgroup ID.

For illustration, an example operation of an AMF may be described as below.

The AMF initiates the Paging procedure by sending the (CN) PAGING message to the NG-RAN node.

If the UE Radio Capability for Paging IE is included in the (CN) PAGING message, and the LP WUS capability is indicated, the NG-RAN node may use it to apply specific paging schemes.

If the LP-WUS Assistance Information IE is included in the (CN) PAGING message, and the cell list for LP WUS is present, the NG-RAN node may, based on the cell list information, decide whether to apply LP WUS to wake up the UE prior to sending Un paging message to the UE.

If the LP-WUS Assistance Information IE is included in the (CN) PAGING message, and subgroup info is present, the NG-RAN node may, based on the subgroup information, may apply subgroup based LP WUS (e.g., carrying a subgroup ID) to wake up UE prior to sending Un paging message to the UE.

With reference to FIG. 4, upon reception of the Ng paging message, the access network device 120 may determine 430 application of a LP WUS for the terminal device 110. In this example, the cell 121 is in the cell list, and thus the access network device 120 may apply 440 the LP WUS and transmit a Uu paging message. Then if the terminal device 110 is in the cell 121, the terminal device 110 may monitor 450 the LP WUS. Upon reception of the LP WUS, the terminal device 110 may wake up to monitor the Uu paging message.

Upon reception of the Ng paging message, the access network device 130 may also determine 460 application of a LP WUS for the terminal device 110. In this example, the cell 131 is not in the cell list, and thus the access network device 130 may not apply the LP WUS and may follow a legacy procedure. For example, the access network device 130 may transmit 470 at least one of PEI or a Uu paging message. Then if the terminal device 110 is in the cell 131, the terminal device 110 may monitor 480 at least one of the PEI or Uu paging message.

For illustration, an example UE behavior may be described as below.

Upon entering LP WUS mode, the UE shall:
1> if the cell list (for LP WUS monitoring) is configured in e.g., LP WUS configuration:
2> if the cell that the UE is currently camping on belongs to one of the cell list:
   3> keep monitoring LP WUS in this cell (or, maintain LP WUS mode);
2> else:
   3> stop monitoring LP WUS (or, exit LP WUS mode but may store the LP WUS configuration);
   3> perform the RRC_IDLE/INACTIVE related actions (i.e., reading SSB/SI, paging monitoring, measurements).

It is to be understood that other details of operations in the process 400 are similar to that described in connection with the process 300, and thus are not repeated here for concise.

### Embodiment 4

In this embodiment, the paging message is a RAN paging message, e.g., an Xn paging message.

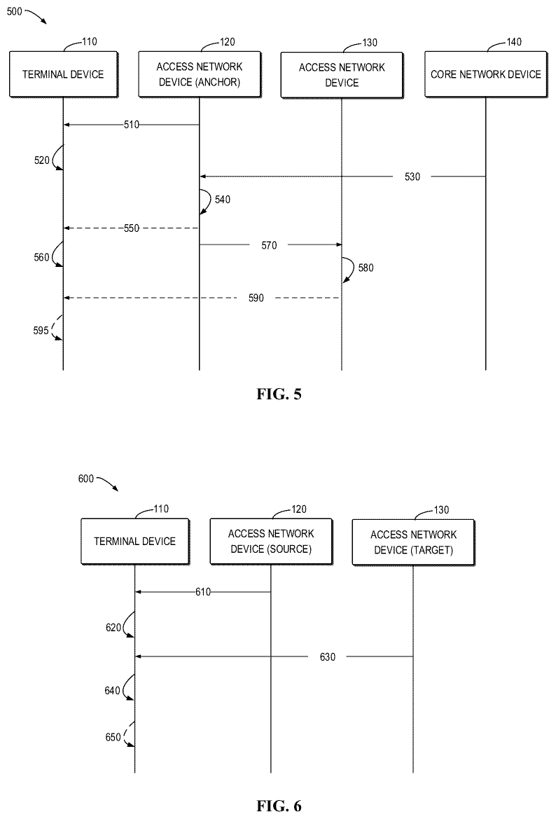

FIG. 5 illustrates a schematic diagram illustrating an example process 500 of communication in RAN paging according to embodiments of the present disclosure. For the purpose of discussion, the process 500 will be described with reference to FIG. 1A. It is to be understood that the steps and the order of the steps in FIG. 5 are merely for illustration, and not for limitation. For example, the order of the steps may be changed. Some of the steps may be omitted or any other suitable additional steps may be added. It is assumed that the access network device 120 provides an anchor cell and the access network device 130 has no cell comprised in a set of cells in which the terminal device 110 supports a LP WUS.

As shown in FIG. 5, the access network device 120 may transmit 510 an indication that the terminal device 110 enters a LP WUS mode. In this way, the terminal device 110 is triggered to enter the LP WUS mode. The access network device 120 may store 520 information of the terminal device 110 for a LP WUS. For example, the information of the terminal device 110 may be stored in a UE Inactive access stratum (AS) Context. It is to be understood that any other suitable ways are also feasible.

In some embodiments, the information of the terminal device 110 may comprise an indication indicating that the terminal device 110 supports the LP WUS. In some embodiments, the information of the terminal device 110 may comprise information of a set of cells in which the terminal device 110 supports the LP WUS. In some embodiments, the information of the terminal device 110 may comprise information of an ID of a group comprising the terminal device 110. It is to be understood that the information of the terminal device 110 may comprise any combination of the above information.

Continue to refer to FIG. 5, the access network device 120 may receive 530 data from the core network device 140. As the data is directed to the terminal device 110 and the terminal device 110 is in the LP WUS mode, the access network device 120 may determine 540 application of a LP WUS for the terminal device 110. In this example, the cell 121 is in the cell list, and thus the access network device 120 may apply 550 the LP WUS and transmit a Uu paging message. Then if the terminal device 110 is in the cell 121, the terminal device 110 may monitor 560 the LP WUS. Upon reception of the LP WUS, the terminal device 110 may wake up to monitor the Uu paging message.

Continue to refer to FIG. 5, the access network device 120 may also transmit 570 an Xn paging message (i.e., the paging message described in FIG. 3) in RAN area for paging the terminal device 110. Accordingly, the access network device 130 may receive the Xn paging message.

In some embodiments, the access network device 120 may introduce, in an information element (IE) “UE Radio Capability for Paging” of the Xn paging message, the indication indicating that the terminal device 110 supports the LP WUS. In some embodiments, the access network device 120 may introduce an IE “LP-WUS Assistance Information” in the Xn paging message to carry the information of the set of cells in which the terminal device 110 supports the LP WUS and the information of the ID of the group comprising the terminal device 110. For example, an Xn paging message may be designed as below.

### RAN PAGING

This message is sent by the NG-RAN node, to NG-RAN node, to page a UE.

Direction: NG-RAN node₁→NG-RAN node2.

IE/Group Name

```
Message Type
CHOICE UE Identity Index
Value
  >Length-10
    >>Index Length-10
UE RAN Paging Identity
Paging DRX
RAN Paging Area
Paging Priority
Assistance Data for RAN Paging
UE Radio Capability for Paging
Extended UE Identity Index
Value
E-UTRA Paging eDRX
Information
UE specific DRX
NR Paging eDRX Information
NR Paging eDRX Information for
RRC INACTIVE
Paging Cause
PEIPS Assistance Information
LP-WUS Assistance Information
```

The IE “UE Radio Capability for Paging” may be designed as below.

UERadioPagingInformation-v1800-IEs ::= SEQUENCE {

| | |
|---|---|
| ue-RadioPagingInfo-r18 | OCTET STRING (CONTAINING UE-RadioPagingInfo-r18) |

}

| | |
|---|---|
| UE-RadioPagingInfo-r18 ::= | SEQUENCE { |
| lp-wus-SupportBandList-r18 | SEQUENCE (SIZE (1..maxBands)) OF FreqBandIndicatorNR |

...
}

The IE “LP-WUS Assistance Information” may comprise the following items:

Cell list for LPWUS: when present in the RAN paging message received by a gNB, it indicates the gNB whether to apply a LP WUS to wake up the UE based on the cell list prior to sending the Uu paging message to the UE. The cell list includes a list of cells information, each cell information can be denoted by PhysCellId (PCI), CellIdentity (or plus PLMN); and

Subgroup info for LPWUS: a subgroup ID which is used to differentiate a group of UE within one LP WUS occasion, or related configuration used to calculate subgroup ID.

For illustration, an example operation of an anchor gNB or serving gNB may be described as below.

The serving/anchor gNB may store in the UE Inactive AS Context, the LP WUS capability, the cell list for LP WUS, subgroup info for LP WUS as assistance information for RAN paging.

The RAN Paging procedure is triggered by the NG-RAN node1 by sending the RAN PAGING message to the NG-RAN node2, in which the necessary information e.g. UE RAN Paging Identity, LP WUS Assistance Information should be provided.

If the UE Radio Capability for Paging IE is included in the RAN PAGING message, and the LPWUS capability is indicated, the NG-RAN node2 may use it to apply specific paging schemes.

If the LP WUS Assistance Information IE is included in the RAN PAGING message, and the cell list for LP WUS is present, the NG-RAN node2 may, based on the cell list information, decide whether to apply LP WUS to wake up the UE or not prior to sending the Uu paging message to UE.

If the LP-WUS Assistance Information IE is included in the RAN PAGING message, and subgroup info is present, the NG-RAN node2 may, based on the subgroup information, may apply subgroup based LP WUS (e.g., carrying a subgroup ID) to wake up UE prior to sending Un paging message to the UE.

With reference to FIG. 5, upon reception of the Xn paging message, the access network device 130 may determine 580 application of a LP WUS for the terminal device 110. In this example, the cell 131 is not in the cell list, and thus the access network device 130 may not apply the LP WUS and may follow a legacy procedure. For example, the access network device 130 may transmit 590 at least one of PEI or a Uu paging message.

Then if the terminal device 110 is in the cell 131, the terminal device 110 may monitor 595 at least one of the PEI or Uu paging message. The behavior of the terminal device 110 is similar to that in Embodiment 4, and thus is not repeated here for concise.

It is to be understood that other details of operations in the process 500 are similar to that described in connection with the process 300, and thus are not repeated here for concise.

With any of the processes 300 to 500, efficient paging via a LP WUS may be achieved.

### Example Implementation of LP WUS Configuration

In some scenarios, different cells may provide different LP WUS configurations. To support mobility in a LP WUS mode, how to obtain a LP WUS configuration on a changing cell needs to be specified. Thus, embodiments of the present disclosure provide a solution of obtaining a LP WUS configuration. The solution will be described in connection with FIG. 6.

FIG. 6 illustrates a schematic diagram illustrating a process 600 of communication according to embodiments of the present disclosure. For the purpose of discussion, the process 600 will be described with reference to FIG. 1A. It is to be understood that the steps and the order of the steps in FIG. 6 are merely for illustration, and not for limitation. For example, the order of the steps may be changed. Some of the steps may be omitted or any other suitable additional steps may be added. It is assumed that the terminal device 110 in a LP WUS mode will move from the cell 121 to the cell 131.

As shown in FIG. 6, when the terminal device 110 is in the cell 121, the access network device 120 may transmit 610 a configuration for a LP WUS to the terminal device 110. It is to be understood that any of the access network devices 120 and 130 may be an anchor network device or may not be anchor network device in this example.

When the terminal device 110 moves from the cell 121 to the cell 131, the terminal device 110 may determine 620 whether the cell 131 is comprised in a set of cells in which the terminal device 110 supports the LP WUS. Information of the set of cells may be comprised in the configuration for the LP WUS received from the access network device 120.

In some embodiments, different cells may provide different LP WUS configurations via system information. If the cell 131 is not comprised in the set of cells, the terminal device 110 may acquire 630 a further configuration for the LP WUS. In some embodiments, the terminal device 110 may acquire, from the cell 131, system information comprising the further configuration. Upon acquiring of the further configuration, the terminal device 110 may monitor 640 the LP WUS.

For illustration, an example procedure may be described as below.

When monitoring LP WUS, the UE shall:
1> if cell (re) selection/change occurs while monitoring LP WUS in a cell and this new cell is different from the cell where the UE receives the LP WUS configuration; and
1> if the cell list for LP WUS (if available) does not indicate this new cell:
   2> acquire the system information for LP WUS configuration (e.g., turn on the main radio to immediately acquire LP WUS configuration via SI before continuously monitoring LP WUS on the new cell);
   2> monitor LP WUS (or, enter LP WUS mode) after acquiring the LP WUS configuration.

In some embodiments, a LP WUS configuration may be provided via a dedicated signaling. If the cell 131 is not comprised in the set of cells, the terminal device 110 may exit 650 the LP WUS mode. In some embodiments, the terminal device 110 may stop monitoring of the LP WUS, and perform an operation related to an idle or inactive state. Alternatively, the terminal device 110 may initiate a random access procedure for acquisition of the further configuration.

For illustration, an example procedure may be described as below.

When monitoring LP WUS, the UE shall:
1> if cell (re) selection/change occurs while monitoring LP WUS in a cell and this new cell is different from the cell where UE receives the LP WUS configuration; and
1> if the cell list for LP WUS (if available) does not indicate this new cell:
   (opt.1) 2> stop monitoring LP WUS (or, exit LP WUS mode);
   (opt.1) 2> perform the RRC_IDLE/INACTIVE related actions (i.e., enter RRC_IDLE/INACTIVE reading SSB/SI, paging monitoring, measurements);
   (opt.2) 2> initiate Random access for LP WUS configuration acquisition.

With the process 600, a proper LP WUS configuration may be ensured during mobility in a LP WUS mode.

### Example Implementation of Methods

Corresponding to the above processes, embodiments of the present disclosure provide methods of communication implemented at a terminal device and a network device. These methods will be described below with reference to FIGS. 7 to 12.

FIG. 7 illustrates an example method 700 of communication implemented at a terminal device in accordance with some embodiments of the present disclosure. For example, the method 700 may be performed at the terminal device 110 as shown in FIG. 1A. For the purpose of discussion, in the following, the method 700 will be described with reference to FIG. 1A. It is to be understood that the method 700 may include additional blocks not shown and/or may omit some blocks as shown, and the scope of the present disclosure is not limited in this regard.

At block 710, the terminal device 110 receives, from an access network device (e.g., the access network device 120 or 130), an indication indicating that a LP WUS monitoring is performed in a first cell. The terminal device enters the LP WUS mode in the first cell. That is, the entering of the LP WUS mode is triggered by the first cell.

In some embodiments, the access network device may provide a second cell. If a cell change to the second cell occurs, the terminal device 110 may acquire system information from the access network device, the system information comprising the indication.

In some embodiments, if the system information comprises an indication indicating that a PEI monitoring is performed in the first cell, the terminal device 110 may determine that the indication is received.

In some embodiments, the terminal device 110 may receive, from the access network device, a signaling dedicated for the terminal device 110 comprising the indication.

At block 720, the terminal device 110 determines whether the terminal device 110 is in the first cell. If the terminal device 110 is in the first cell, the method 700 proceeds to block 730.

At block 730, the terminal device 110 performs the LP WUS monitoring. In some embodiments, if the second cell is the first cell, the terminal device 110 may perform the LP WUS monitoring in the second cell. If the second cell is not the first cell, the terminal device 110 may not perform the LP WUS monitoring in the second cell. In some embodiments, if the system information does not comprise the indication, the terminal device 110 may perform the LP WUS monitoring in the second cell.

In some embodiments where the signaling comprising the indication is received, the signaling further comprises applicable area information. If the second cell is in an area indicated by the applicable area information and the second cell is the first cell, the terminal device 110 may perform the LP WUS monitoring in the second cell. If the second cell is in the area indicated by the applicable area information and the second cell is not the first cell, the terminal device 110 may not perform the LP WUS monitoring in the second cell. If the second cell is out of the area indicated by the applicable area information, the terminal device 110 may perform the LP WUS monitoring in the second cell if the second cell supports the LP WUS.

In some embodiments, if the terminal device 110 is to enter the LP WUS mode in the first cell, the terminal device 110 may store information of the first cell.

With the method 700, unnecessary LP WUS monitoring may be avoided and further power saving may be achieved.

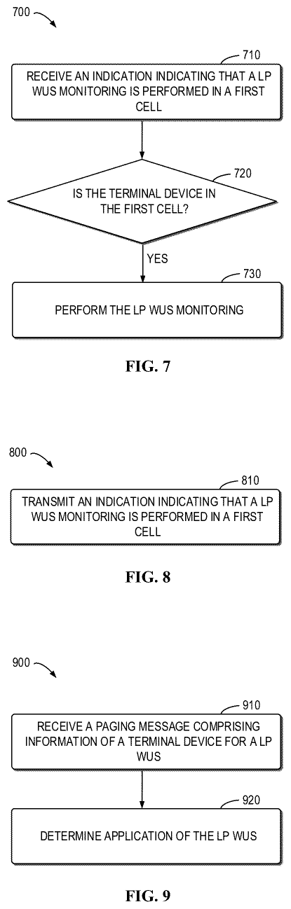

FIG. 8 illustrates an example method 800 of communication implemented at an access network device in accordance with some embodiments of the present disclosure. For example, the method 800 may be performed at the access network device 120 or 130 as shown in FIG. 1A. For the purpose of discussion, in the following, the method 800 will be described with reference to the access network device 120 of FIG. 1A. It is to be understood that the method 800 may include additional blocks not shown and/or may omit some blocks as shown, and the scope of the present disclosure is not limited in this regard.

At block 810, the access network device 120 transmits, to the terminal device 110, an indication indicating that a LP WUS monitoring is performed in a first cell. The terminal device enters the LP WUS mode in the first cell. That is, the entering of the LP WUS mode is triggered by the first cell.

In some embodiments, the access network device 120 may broadcast system information comprising the indication. In some embodiments, the access network device 120 may broadcast system information comprising an indication indicating that a PEI monitoring is performed in the first cell. In some embodiments, the access network device 120 may transmit, to the terminal device 110, a signaling dedicated for the terminal device 110 comprising the indication. In some embodiments, the signaling may further comprise applicable area information. It is to be understood that any combination of the above manners is also feasible.

In some embodiments where the access network device provides an anchor cell, if the terminal device 110 is to enter the LP WUS mode in the first cell, the access network device 120 may store information of the terminal device 110. Alternatively or additionally, the access network device 120 may transmit, to the core network device 140, information of the first cell associated with the terminal device 110.

With the method 800, unnecessary LP WUS monitoring may be avoided and further power saving may be achieved.

FIG. 9 illustrates another example method 900 of communication implemented at an access network device in accordance with some embodiments of the present disclosure. For example, the method 900 may be performed at the access network device 120 or 130 as shown in FIG. 1A. For the purpose of discussion, in the following, the method 900 will be described with reference to the access network device 120 of FIG. 1A. It is to be understood that the method 900 may include additional blocks not shown and/or may omit some blocks as shown, and the scope of the present disclosure is not limited in this regard.

At block 910, the access network device 120 receives a paging message for the terminal device 110, the paging message comprising information of the terminal device for a LP WUS.

In some embodiments, the information of the terminal device may comprise at least one of the following: an indication indicating that the terminal device 110 supports the LP WUS; information of a set of cells in which the terminal device 110 supports the LP WUS; or information of an ID of a group comprising the terminal device 110.

At block 920, the access network device 120 determines application of the LP WUS based on the information of the terminal device 110.

In some embodiments, if the paging message comprises the indication indicating that the terminal device 110 supports the LP WUS, the access network device 120 may determine that the LP WUS is applied to the terminal device 110.

In some embodiments, if the paging message comprises the information of the set of cells in which the terminal device 110 supports the LP WUS, the access network device 120 may determine, based on the information of the set of cells, whether the LP WUS is applied to the terminal device 110.

In some embodiments, if the paging message comprises the information of the ID of the group comprising the terminal device 110, the access network device 120 may determine, based on the information of the ID of the group, that the LP WUS is applied to the group.

In some embodiments where the access network device 120 provides an anchor cell, the access network device 120 transmits, to the core network device 140, assistance information for paging. The assistance information may comprise at least one of the following: an indication indicating that the terminal device 110 supports the LP WUS; information of a set of cells in which the terminal device 110 supports the LP WUS; or information of an ID of a group comprising the terminal device 110.

With the method 900, a network may be aware of information of a terminal device for a LP WUS, and efficient paging may be facilitated.

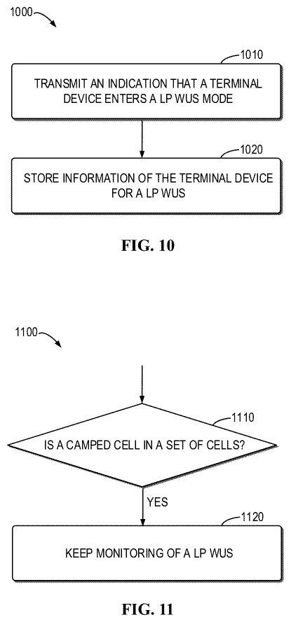

FIG. 10 illustrates still another example method 1000 of communication implemented at an access network device in accordance with some embodiments of the present disclosure. For example, the method 1000 may be performed at an access network device providing an anchor cell (e.g., the access network device 120 as shown in FIG. 1A). For the purpose of discussion, in the following, the method 1000 will be described with reference to the access network device 120 of FIG. 1A. It is to be understood that the method 1000 may include additional blocks not shown and/or may omit some blocks as shown, and the scope of the present disclosure is not limited in this regard.

At block 1010, the access network device 120 transmits, to the terminal device 110, an indication that the terminal device 110 enters a LP WUS mode.

At block 1020, the access network device 120 stores information of the terminal device 110 for a LP WUS. In some embodiments, the information of the terminal device 110 may comprise at least one of the following: an indication indicating that the terminal device 110 supports the LP WUS; information of a set of cells in which the terminal device 110 supports the LP WUS; or information of an ID of a group comprising the terminal device 110.

With the method 1000, information of a terminal device for a LP WUS may be stored by a network, and efficient paging may be facilitated.

FIG. 11 illustrates another example method 1100 of communication implemented at a terminal device in accordance with some embodiments of the present disclosure. For example, the method 1100 may be performed at the terminal device 110 as shown in FIG. 1A). For the purpose of discussion, in the following, the method 1100 will be described with reference to FIG. 1A. It is to be understood that the method 1100 may include additional blocks not shown and/or may omit some blocks as shown, and the scope of the present disclosure is not limited in this regard. The terminal device 110 is in a LP WUS mode.

At block 1110, the terminal device 110 determines whether a cell that the terminal device 110 is camping on is comprised in a set of cells. The terminal device 110 supports the LP WUS in the set of cells. If the cell is comprised in the set of cells, the method 1100 proceeds to block 1120.

At block 1120, the terminal device 110 keeps monitoring of the LP WUS.

In some embodiments, if the terminal device 110 determines that the cell is not comprised in the set of cells, the terminal device 110 may stop the monitoring of the LP WUS, and perform an operation related to an idle or inactive state.

With the method 1100, unnecessary LP WUS monitoring may be avoided.

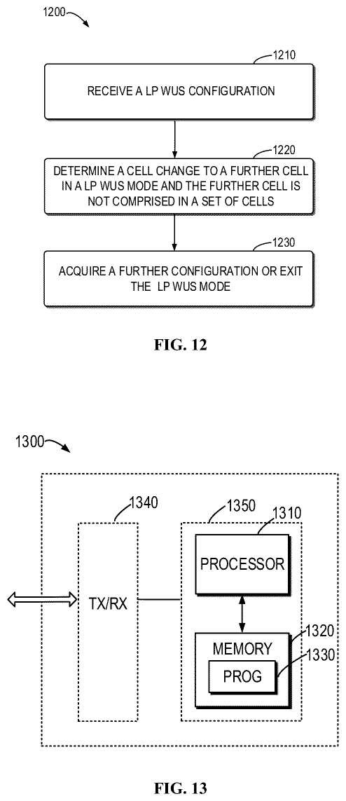

FIG. 12 illustrates a still another example method 1200 of communication implemented at a terminal device in accordance with some embodiments of the present disclosure. For example, the method 1200 may be performed at the terminal device 110 as shown in FIG. 1A). For the purpose of discussion, in the following, the method 1200 will be described with reference to FIG. 1A. It is to be understood that the method 1200 may include additional blocks not shown and/or may omit some blocks as shown, and the scope of the present disclosure is not limited in this regard. The terminal device 110 is in a LP WUS mode.

At block 1210, the terminal device 110 receives, in a cell, a configuration for a LP WUS.

At block 1220, the terminal device 110 determines that a cell change from the cell to a further cell occurs in a LP WUS mode and the further cell is not comprised in a set of cells in which the terminal device supports the LP WUS.

At block 1230, the terminal device 110 acquires a further configuration for the LP WUS or exits the LP WUS mode. In some embodiments for acquiring the further configuration, the terminal device 110 may acquire, from the further cell, system information comprising the further configuration. If the further configuration is acquired, the terminal device may monitor the LP WUS. In some alternative embodiments, the terminal device 110 may initiate a random access procedure for acquisition of the further configuration.

In some embodiments for exiting the LP WUS mode, the terminal device 110 may stop monitoring of the LP WUS, and perform an operation related to an idle or inactive state.

With the method 1200, a proper LP WUS configuration may be ensured for mobility in a LP WUS mode.

It is to be understood that operations of the methods 700 to 1200 correspond to the processes described in connection with FIGS. 2 to 6, and thus other details are omitted here for concise.

### Example Implementation of Device and Apparatus

FIG. 13 is a simplified block diagram of a device 1300 that is suitable for implementing embodiments of the present disclosure. The device 1300 can be considered as a further example implementation of the terminal device 110 or the access network device 120 or 130 or the core network device 140 as shown in FIG. 1A. Accordingly, the device 1300 can be implemented at or as at least a part of the terminal device 110 or the access network device 120 or 130 or the core network device 140.

As shown, the device 1300 includes a processor 1310, a memory 1320 coupled to the processor 1310, a suitable transmitter (TX) and receiver (RX) 1340 coupled to the processor 1310, and a communication interface coupled to the TX/RX 1340. The memory 1310 stores at least a part of a program 1330. The TX/RX 1340 is for bidirectional communications. The TX/RX 1340 has at least one antenna to facilitate communication, though in practice an Access Node mentioned in this application may have several ones.

The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1330 is assumed to include program instructions that, when executed by the associated processor 1310, enable the device 1300 to operate in accordance with the embodiments of the present disclosure, as discussed herein with reference to FIGS. 1A to 12. The embodiments herein may be implemented by computer software executable by the processor 1310 of the device 1300, or by hardware, or by a combination of software and hardware. The processor 1310 may be configured to implement various embodiments of the present disclosure. Furthermore, a combination of the processor 1310 and memory 1320 may form processing means 1350 adapted to implement various embodiments of the present disclosure.

The memory 1320 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1320 is shown in the device 1300, there may be several physically distinct memory modules in the device 1300. The processor 1310 may be of any type suitable to the local technical network, and may include one or more of general purpose computers, special purpose computers, microprocessors, digital signal processors (DSPs) and processors based on multicore processor architecture, as non-limiting examples. The device 1300 may have multiple processors, such as an application specific integrated circuit chip that is slaved in time to a clock which synchronizes the main processor.

In some embodiments, a terminal device comprises a circuitry configured to: receive, from an access network device, an indication indicating that a low-power wake-up signal, LP WUS, monitoring is performed in a first cell, the terminal device entering the LP WUS mode in the first cell; and in accordance with a determination that the terminal device is in the first cell, perform the LP WUS monitoring.

In some embodiments, an access network device comprises a circuitry configured to: transmit, to a terminal device, an indication indicating that a low-power wake-up signal, LP WUS, monitoring is performed in a first cell, the terminal device entering the LP WUS mode in the first cell.

In some embodiments, an access network device comprises a circuitry configured to: receive a paging message for a terminal device, the paging message comprising information of the terminal device for a low-power wake-up signal, LP WUS; and determine application of the LP WUS based on the information of the terminal device.

In some embodiments, an access network device comprises a circuitry configured to: transmit, to a terminal device, an indication that the terminal device enters a low-power wake-up signal, LP WUS, mode; and store information of the terminal device for a LP WUS.

In some embodiments, a terminal device comprises a circuitry configured to: determine, in a low-power wake-up signal, LP WUS, mode, that a cell that the terminal device is camping on is comprised in a set of cells, the terminal device supporting the LP WUS in the set of cells; and keep monitoring of the LP WUS.

In some embodiments, a terminal device comprises a circuitry configured to: receive, in a cell, a configuration for a lower-power wake-up signal, LP WUS; and in accordance with a determination that a cell change from the cell to a further cell occurs in a LP WUS mode and the further cell is not comprised in a set of cells in which the terminal device supports the LP WUS, acquire a further configuration for the LP WUS or exiting the LP WUS mode.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure may provide the following solutions.

In one solution, a method of communication comprises: receiving, at a terminal device and from an access network device, an indication indicating that a low-power wake-up signal, LP WUS, monitoring is performed in a first cell, the terminal device entering the LP WUS mode in the first cell; and in accordance with a determination that the terminal device is in the first cell, performing the LP WUS monitoring.

In some embodiments, the access network device provides a second cell. In these embodiments, receiving the indication comprises: in accordance with a determination that a cell change to the second cell occurs, acquiring system information from the access network device, the system information comprising the indication. In these embodiments, performing the LP WUS monitoring comprises: in accordance with a determination that the second cell is the first cell, performing the LP WUS monitoring in the second cell; and in accordance with a determination that the second cell is not the first cell, performing no LP WUS monitoring in the second cell.

In some embodiments, the method above further comprises: in accordance with a determination that the system information does not comprise the indication, performing the LP WUS monitoring in the second cell.

In some embodiments, the method above further comprises: in accordance with a determination that the system information comprises an indication indicating that a paging early indication, PEI, monitoring is performed in the first cell, determining that the indication is received.

In some embodiments, receiving the indication comprises: receiving, from the access network device, a signaling dedicated for the terminal device comprising the indication.

In some embodiments, the signaling comprises applicable area information and the access network device provides a second cell. In these embodiments, performing the LP WUS monitoring comprises: in accordance with a determination that the second cell is in an area indicated by the applicable area information and the second cell is the first cell, performing the LP WUS monitoring in the second cell; in accordance with a determination that the second cell is in the area indicated by the applicable area information and the second cell is not the first cell, performing no LP WUS monitoring in the second cell; and in accordance with a determination that the second cell is out of the area indicated by the applicable area information, performing the LP WUS monitoring in the second cell.

In some embodiments, the method above further comprises: in accordance with a determination that the terminal device is to enter the LP WUS mode in the first cell, storing information of the first cell.

In another solution, a method of communication comprises: transmitting, at an access network device and to a terminal device, an indication indicating that a low-power wake-up signal, LP WUS, monitoring is performed in a first cell, the terminal device entering the LP WUS mode in the first cell.

In some embodiments, transmitting the indication comprises at least one of the following: broadcasting system information comprising the indication; broadcasting system information comprising an indication indicating that a paging early indication, PEI, monitoring is performed in the first cell; or transmitting, to the terminal device, a signaling dedicated for the terminal device comprising the indication.

In some embodiments, the signaling comprises applicable area information.

In some embodiments, the method above further comprises at least one of the following: in accordance with a determination that the terminal device is to enter the LP WUS mode in the first cell, storing information of the terminal device; or transmitting, to a core network device, information of the first cell associated with the terminal device.

In another solution, a method of communication comprises: receiving, at an access network device, a paging message for a terminal device, the paging message comprising information of the terminal device for a low-power wake-up signal, LP WUS; and determining application of the LP WUS based on the information of the terminal device.

In some embodiments, the information of the terminal device comprises at least one of the following: an indication indicating that the terminal device supports the LP WUS; information of a set of cells in which the terminal device supports the LP WUS; or information of an identity of a group comprising the terminal device.

In some embodiments, determining the application of the LP WUS comprises at least one of the following: in accordance with a determination that the paging message comprises the indication indicating that the terminal device supports the LP WUS, determining that the LP WUS is applied to the terminal device; in accordance with a determination that the paging message comprises the information of the set of cells in which the terminal device supports the LP WUS, determining, based on the information of the set of cells, whether the LP WUS is applied to the terminal device; or in accordance with a determination that the paging message comprises the information of the identity of the group comprising the terminal device, determining, based on the information of the identity of the group, that the LP WUS is applied to the group.

In some embodiments, the method above further comprises: transmitting, to a core network device, assistance information for paging comprising at least one of the following: an indication indicating that the terminal device supports the LP WUS; information of a set of cells in which the terminal device supports the LP WUS; or information of an identity of a group comprising the terminal device.

In another solution, a method of communication comprises: transmitting, at an access network device and to a terminal device, an indication that the terminal device enters a low-power wake-up signal, LP WUS, mode; and storing information of the terminal device for a LP WUS.

In some embodiments, the information of the terminal device comprises at least one of the following: an indication indicating that the terminal device supports the LP WUS; information of a set of cells in which the terminal device supports the LP WUS; or information of an identity of a group comprising the terminal device.

In another solution, a method of communication comprises: determining, at a terminal device in a low-power wake-up signal, LP WUS, mode, that a cell that the terminal device is camping on is comprised in a set of cells, the terminal device supporting the LP WUS in the set of cells; and keeping monitoring of the LP WUS.

In some embodiments, the method above further comprises: determining that the cell that the terminal device is camping on is not comprised in the set of cells; stopping the monitoring of the LP WUS; and performing an operation related to an idle or inactive state.

In another solution, a method of communication comprises: receiving, at a terminal device and in a cell, a configuration for a lower-power wake-up signal, LP WUS; and in accordance with a determination that a cell change from the cell to a further cell occurs in a LP WUS mode and the further cell is not comprised in a set of cells in which the terminal device supports the LP WUS, acquiring a further configuration for the LP WUS or exiting the LP WUS mode.

In some embodiments, acquiring the further configuration comprises: acquiring system information from the further cell, the system information comprising the further configuration.

In some embodiments, the method above further comprises: in accordance with a determination that the further configuration is acquired, monitoring the LP WUS.

In some embodiments, exiting the LP WUS mode comprises: stopping monitoring of the LP WUS; and performing an operation related to an idle or inactive state.

In some embodiments, acquiring the further configuration comprises: initiating a random access procedure for acquisition of the further configuration.

In another solution, a device of communication comprises: a processor configured to cause the device to perform any of the methods above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1A to 13. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
receiving, at a terminal device and from an access network device, an indication indicating that a low-power wake-up signal, LP WUS, monitoring is performed in a first cell, the terminal device entering the LP WUS mode in the first cell; and
in accordance with a determination that the terminal device is in the first cell, performing the LP WUS monitoring.

2. The method of claim 1, wherein the access network device provides a second cell, and wherein receiving the indication comprises:
in accordance with a determination that a cell change to the second cell occurs, acquiring system information from the access network device, the system information comprising the indication; and
wherein performing the LP WUS monitoring comprises:
in accordance with a determination that the second cell is the first cell, performing the LP WUS monitoring in the second cell; and
in accordance with a determination that the second cell is not the first cell, performing no LP WUS monitoring in the second cell.

3. The method of claim 2, further comprising:
in accordance with a determination that the system information does not comprise the indication, performing the LP WUS monitoring in the second cell.

4. The method of claim 2, further comprising:
in accordance with a determination that the system information comprises an indication indicating that a paging early indication, PEI, monitoring is performed in the first cell, determining that the indication is received.

5. The method of claim 1, wherein receiving the indication comprises:
receiving, from the access network device, a signaling dedicated for the terminal device comprising the indication.

6. The method of claim 5, wherein the signaling comprises applicable area information and the access network device provides a second cell, and wherein performing the LP WUS monitoring comprises:
in accordance with a determination that the second cell is in an area indicated by the applicable area information and the second cell is the first cell, performing the LP WUS monitoring in the second cell;
in accordance with a determination that the second cell is in the area indicated by the applicable area information and the second cell is not the first cell, performing no LP WUS monitoring in the second cell; and
in accordance with a determination that the second cell is out of the area indicated by the applicable area information, performing the LP WUS monitoring in the second cell.

7. The method of claim 1, further comprising:
in accordance with a determination that the terminal device is to enter the LP WUS mode in the first cell, storing information of the first cell.

8. A method of communication, comprising:
receiving, at an access network device, a paging message for a terminal device, the paging message comprising information of the terminal device for a low-power wake-up signal, LP WUS; and
determining application of the LP WUS based on the information of the terminal device.

9. The method of claim 8, wherein the information of the terminal device comprises at least one of the following:
an indication indicating that the terminal device supports the LP WUS;
information of a set of cells in which the terminal device supports the LP WUS; or
information of an identity of a group comprising the terminal device.

10. The method of claim 9, wherein determining the application of the LP WUS comprises at least one of the following:
in accordance with a determination that the paging message comprises the indication indicating that the terminal device supports the LP WUS, determining that the LP WUS is applied to the terminal device;
in accordance with a determination that the paging message comprises the information of the set of cells in which the terminal device supports the LP WUS, determining, based on the information of the set of cells, whether the LP WUS is applied to the terminal device; or
in accordance with a determination that the paging message comprises the information of the identity of the group comprising the terminal device, determining, based on the information of the identity of the group, that the LP WUS is applied to the group.

11. The method of claim 8, further comprising:
transmitting, to a core network device, assistance information for paging comprising at least one of the following:
an indication indicating that the terminal device supports the LP WUS;
information of a set of cells in which the terminal device supports the LP WUS; or
information of an identity of a group comprising the terminal device.

12. A method of communication, comprising:
receiving, at a terminal device and in a cell, a configuration for a lower-power wake-up signal, LP WUS; and
in accordance with a determination that a cell change from the cell to a further cell occurs in a LP WUS mode and the further cell is not comprised in a set of cells in which the terminal device supports the LP WUS, acquiring a further configuration for the LP WUS or exiting the LP WUS mode.

13. The method of claim 12, wherein acquiring the further configuration comprises:
acquiring system information from the further cell, the system information comprising the further configuration.

14. The method of claim 13, further comprising:
in accordance with a determination that the further configuration is acquired, monitoring the LP WUS.

15. The method of claim 12, wherein exiting the LP WUS mode comprises:
stopping monitoring of the LP WUS; and
performing an operation related to an idle or inactive state.

16. The method of claim 12, wherein acquiring the further configuration comprises:
initiating a random access procedure for acquisition of the further configuration.
